(19) United States
(12) Patent Application Publication
(10) Pub. No.: US 2011/0040717 A1
(43) Pub. Date: Feb. 17, 2011

(54) PROCESS FOR RANKING SEMANTIC WEB RESORUCES

(76) Inventors: Sang-Kyu Rho, Seoul (KR); Hyun-Jung Park, Seoul (KR); Jin-Soo Park, Seoul (KR)

Correspondence Address: IPLA P.A., 3550 WILSHIRE BLVD., 17TH FLOOR, LOS ANGELES, CA, 90010, US

(21) Appl. No.: 12/989,572

(22) PCT Filed: Apr. 22, 2009
(86) PCT No.: PCT/KR2009/002116

§ 371 Date: Oct. 25, 2010

(30) Foreign Application Priority Data
Apr. 23, 2008 (KR) 10-2008-0037877

(51) Int. Cl. G06N 5/02

(52) U.S. Cl. 706/50

(57) ABSTRACT

Disclosed is a process for ranking semantic web resources, comprising the steps of; establishing an RDF knowledge base using diverse tools that support the establishment of ontologies; setting, by class, object and subject weights for an object type attribute and a weight for a data type attribute on the schema composed of classes that constitute a domain and of attributes that describe relationships between these classes; extracting from the RDF knowledge base an RDF triple composed of three portions, i.e., a subject, a predicate and an object; creating a weight matrix of class-oriented attributes based on a set weight and the extracted RDF triple; and operating the created weight matrix of class-oriented attributes to calculate a first eigenvector and obtain a vector for ranking scores of resources.

### TECHNICAL FIELD

The present invention relates to a process for ranking semantic web resources. More particularly, the present invention relates to the process for ranking the semantic web resources which sorts the semantic web resources, namely RDF (Resource Description Framework) resources according to practical importance.

### BACKGROUND ART

Recently, we, who are living in a flood of information, frequently use search engines to find necessary information promptly and accurately. However, because of too many search results, we waste much time and effort selecting information we really need. The more the web improves, the more information will be accumulated. Therefore, to solve the problem like this, many studies on the methods of sorting search results corresponding to user's intention have been conducted, and it seems that the importance of these kinds of studies will increase considerably.

In the traditional search systems which aimed at limitless gathering of independent documents, the degree of importance of the document has been mostly determined by the number of key words found in the document.

Since then, on the WWW (World Wide Web) where each document was hyperlinked to other document, the method of calculating the objective importance score by analyzing the link structure of a huge web graph between the documents was used.

The PageRank algorithm of Google, which appeared in 1998 and has received attention, is a typical example. Link analysis methods such as Google's PageRank suggest higher objective results in a more objective way by using the information that is inherent in the link structure of a web graph. PageRank considers a page more important if it is referred to by more other pages (i.e., it is linked to other pages more). The degree of importance also increases if the importance of the referring pages is higher.

And Kleinberg's HITS(Hypertext Induced Topic Selection) algorithm is another link-structure-based ranking algorithm for web pages. Different from PageRank, the HITS algorithm suggests the method for determining the degree of importance of a web page by introducing two kinds of concepts, such as authority and hub (authority means how many other pages link it, and hub means how many others pages are linked), and calculates two kinds of scores, an authority score and a hub score, for each page. If a page has a high authority score, it is an authority page on a given topic and many other pages refer to it. A page with high hub information refers to many authority pages.

As we can see from these examples, the method that analyzes link structures and utilizes them as ranking scores has become an essential tool for improving satisfaction of the WWW, and the excellence and efficiency of these algorithms have been widely recognized.

Meanwhile, most information from the semantic web can be expressed by an RDF graph because the semantic web is based on the RDF data. The RDF graph, in which a resource and a property (or predicate) are expressed as a node and a link, respectively, is similar to a web graph in which a web page and a hyperlink between documents are expressed as a node and a link, respectively. Consequently, researches on methods for applying the link-structure-based ranking technique of WWW to an RDF graph of the semantic web have great significance.

However, the WWW graph can be considered as an enormous class of the web pages with only one recursive property, namely a property of ‘refers to’. An RDF schema, in contrast, can have various classes and properties, and each link representing a property can have an opposite direction whether the property is an active or passive expression. As a result, an RDF graph of accumulated resources instance based on RDF schemas can be very heterogeneous even when its size is much smaller than that of the WWW graph.

Focusing on the diversity of the semantic web properties, Mukherjea and Bamba modified the HITS algorithm of the WWW and applied this to a method for ranking query results retrieved from RDF knowledge bases. They defined object score and subject score of the semantic web resources, which corresponded to the authority scores and hub scores, respectively, from Kleinberg's definition. They also introduced the concepts of object weight and subject weight in order to control the influence which one resource have on the other resource depending on the characteristics of the properties connecting two resources when calculating each score. Based on this, they actually implemented several semantic web systems and proved the practical feasibility of the algorithm.

However, this method which analyzed link structures and utilized them as ranking scores focusing on properties exposed the limitation of the Tightly-Knit Community (TKC) Effect where nodes that were less important but densely connected were given higher scores than those that were more important but sparsely connected.

Also, there happened another problem that it displayed proper results only in case of the knowledge base where most knowledge was described about the given domain. This means that there could be unexpected results in case the ratio of link numbers to node numbers was too low or some resources are written specifically while others have a meager amount of information.

The above information disclosed in this Background section is only for enhancement of understanding of the background of the invention and therefore it may contain information that does not form the prior art that is already known in this country to a person of ordinary skill in the art.

### SUMMARY OF THE INVENTION

An objective of the present invention is to provide a process for ranking semantic web resources which sorts semantic web resources, namely RDF resources according to practical importance to solve the above-mentioned problem.

Another objective of the present invention is to provide a process for ranking semantic web resources which changes to be class-oriented different from the previous property-oriented approach, when sorting RDF resources, and determines the property weights considering the relative significance of the property which influences on resource importance of each class.

A process for ranking semantic web resources according to the present invention may include establishing an RDF knowledge base using various tools that support the establishment of ontology; setting object and subject weights for an object type property and a weight for a data type property in each class on a schema composed of classes that constitute a domain and of properties that describe relationships between these classes; extracting from the RDF knowledge base an RDF triple composed of a subject, a predicate, and an object; creating a weight matrix of class-oriented property based on the set weights and the extracted RDF triple; and operating the created weight matrix of class-oriented property to calculate a dominant eigenvector and obtain a resource importance score vector.

It is preferable that determining whether SPARQL query is input to obtain the result of the ranking scores through the ontology establishment tool; approaching the result of corresponding SPARQL query when the SPARQL query is input; a sorting and displaying on a screen query results by the ranking scores are further performed after obtaining the eigenvector and the resource importance score vector.

It is preferable that the weights are set such that the sum of the weights in each class is to be 1 considering only the object property, or the sum of weights for the object property and data type property is to be 1.

As described above, according to a process for ranking semantic web resources of the present invention, considering that most queries which need to be ranked require for searching resources in one class ultimately, that there are various classes on an RDF schema, and that people apply different standards to each class, a class-oriented method different from a conventional method of property-oriented is applied when sorting an RDF resources. In addition, weights for each property are set by considering relative weights of properties affecting the resource importance in each class according to the present invention. Therefore, it can solve TKC effect occurring when a link structure is analyzed with property-oriented to obtain ranking scores. It also offers a solution to the problem of schema diversity caused by the randomness of RDF link directions by introducing the concept of interaction between resources unrelated to link directions.

Moreover, data type which was excluded from previous studies can be included in the resource importance calculation, calculation process may become simpler by developing mathematical analysis of matrix operation neglected in previous studies, and it can be applied to many real life ranking issues, such as university rankings or shopping mall rankings because it can be applied to various domains expressed by an RDF graph.

Also, an RDF schema to a domain can be expressed in many forms, depending on each link direction, i.e. whether properties are expressed actively or passively, although it conveys the same information. If the form of the RDF schema changes, the object and subject scores of each resource are affected and original meanings of authority scores and hub scores in the WWW may be lost. Therefore, the present invention which determines the importance of resource considering the interaction of link connections between the resources regardless of link directions is suitable for semantic web where an RDF is a basic data model and which can be applied to various domains of semantic web expressed by an RDF graph. In other words, the present invention provides a solution for the diversity of RDF schema which is the biggest obstacle when applying WWW link analysis technique to RDF graph.

### DESCRIPTION OF THE DRAWINGS

FIG. 1 is a flowchart of a process for ranking semantic web resources according to the present invention,

FIG. 2 is a schematic diagram for explaining exemplary embodiment of setting up class-oriented weight value,

FIG. 3 is a flowchart of explaining processes for calculating the importance of resource considering only object property,

FIG. 4 is a flowchart of explaining processes for calculating the final importance of resource based on the importance of resource considering normalized object and data type properties,

FIG. 5 is a flowchart of explaining processes for calculating the importance of resource considering object property and data type property,

FIG. 6 is a schematic diagram for an exemplary embodiment of class composition applied to a method shown in FIG. 3,

FIG. 7 and FIG. 8 are schematic diagrams of PreRI and ClaRIOne/ClaRITwo weight value for each class, respectively,

FIG. 9 is a schematic diagram of instance and triple numbers of classes shown in FIG. 6,

FIG. 10 is a schematic diagram of property per instance of RESEARCHER class shown in FIG. 6,

FIG. 11 is a schematic diagram of ranking results by PreRI of RESEARCHER class shown in FIG. 6,

FIG. 12 and FIG. 13 are schematic diagrams of ranking results by ClaRITwo of RESEARCHER class and PATENT class, respectively, shown in FIG. 6,

FIG. 14 to FIG. 16 are schematic diagrams of ranking results by ClaRIOne of RESEARCHER class, PATENT class, and FIELD class, respectively, shown in FIG. 6

FIG. 17 is a schematic diagram of calculation of the Spearman's rho correlation coefficients to RESEARCHER class shown in FIG. 6,

FIG. 18 is a schematic diagram of calculation of the Spearman's rho correlation coefficients to entire class shown in FIG. 6,

FIG. 19 is a schematic diagram of examples of class compositions applied to the methods shown in FIG. 4 and FIG. 5,

FIG. 20 is a schematic diagram of instance and triple numbers of classes shown in FIG. 19,

FIG. 21 is a schematic diagram of ranking results of BOOK class shown in FIG. 19 in accordance with the method shown in FIG. 4, and

FIG. 22 is a schematic diagram of ranking results of BOOK class shown in FIG. 19 in accordance with the method shown in FIG. 5.

### DETAILED DESCRIPTION OF THE INVENTION

Prior to the detailed descriptions of the present invention, several terms used in the present invention will be described as follows.

A “semantic web” adds semantic information to a web document using the concept of meta data. Then, software agent extracts this automatically and creates a paradigm which enables to share or expand information. Thus, Tim Berners-Lee defined that the semantic web is not a new concept of a web fully distinguished from the previous web, but is an expansion of a present web, in which computers understand the meaning of information and enable cooperation with people and automated service.

An “ontology” is a language to realize semantic web and plays an important role which enables to share and process knowledge between applications on the web. Tom Gruber defined that ontology is a formal and specific expression of conceptualization shared with a corresponding domain.

An “RDF (Resource Description Framework)” considers every expressible concept as a resource and is a data model which describes property of the resource or the relationship between the resources by using a URIref (Uniform Resource Identifier reference) as an identifier to distinguish these resources. Basic unit thereof is a statement so-called triple which is composed of three portions, i.e. subject-predicate or property-object, RDF statements can also be expressed as an RDF graph composed of nodes and links. A Node corresponds to a resource located in the subject or the object of a statement and a link corresponds to the predicate in a statement.

An “RDF schema (schema)” is a concept expanded from an RDF with frame-base, and became W3C (World Wide Web Consortium) Recommendation in February, 2004. The necessary vocabularies and basic assumptions for describing the composition of a domain and the interactions therebetween can be defined.

Hereinafter, referring to the attached drawings, a process for ranking semantic web resources according to the present invention will be explained in detail.

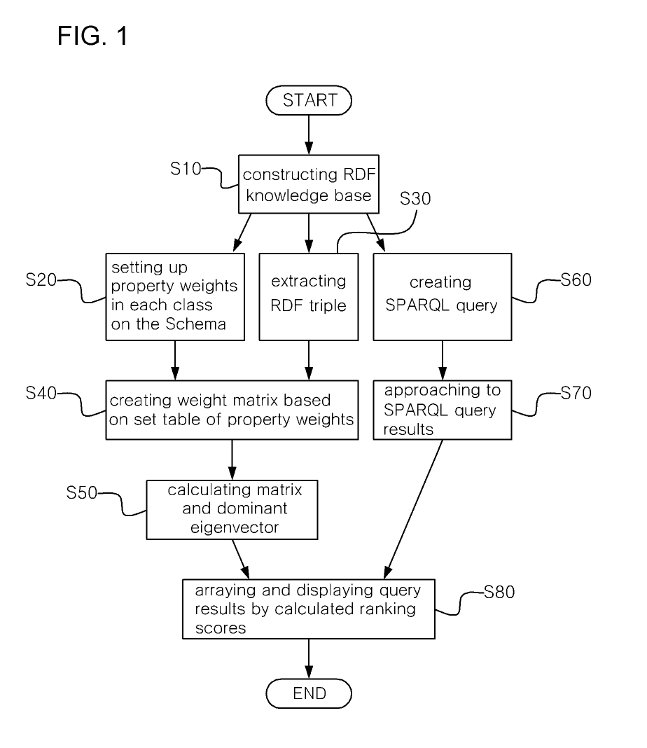

FIG. 1 is a flowchart of a process for ranking semantic web resources according to the present invention, and can be divided into steps S10 to S50 which explains the algorithm for calculating resource importance and steps S60 to S80 which explains the procedure of sorting the calculation results of the resource importance according to SPARQL query.

Firstly, an RDF knowledge base is built at step S10 by using various tools which support every kind of ontology construction as well as protégé. Ideally, it should be designed considering the necessity of ranking instance resources which are accumulated from the beginning of the ontology construction according to importance. It can be applied to RDF knowledge base which was already built.

After building the RDF knowledge base, object weights and subject weights for object type properties and weights for data type properties in each class are set on the schema which is composed of several classes and properties that describe the relationship between these classes at step S20.

A Class is a gathering of elements with common property and each element in the class is called an instance. The target ranking resources of the present invention are instances in this class. The main ideas of the present invention are that the importance of the resources in the same class should be valued by the same standards, and that the standards of the importance should be decided considering the relative weight of the properties connected to the class.

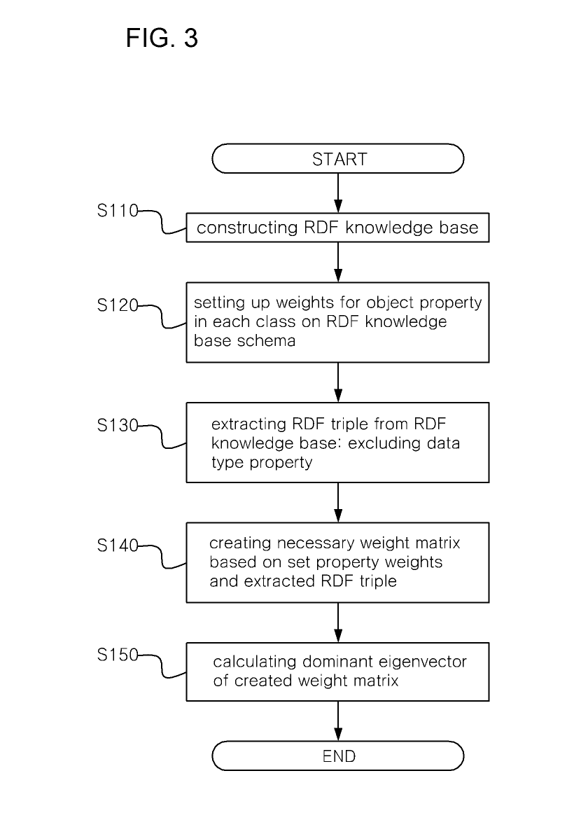

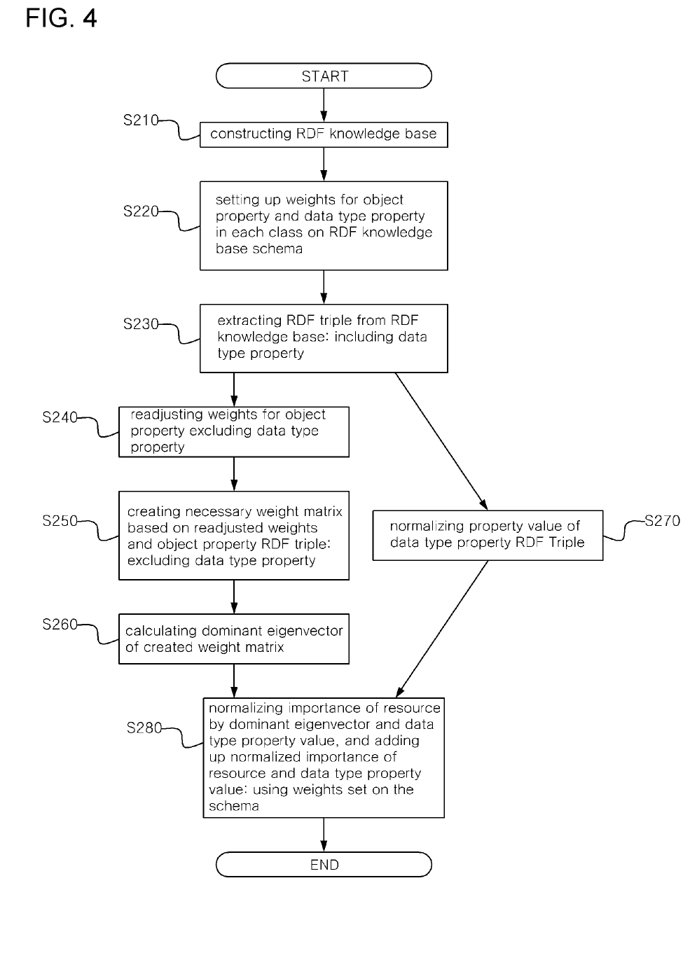

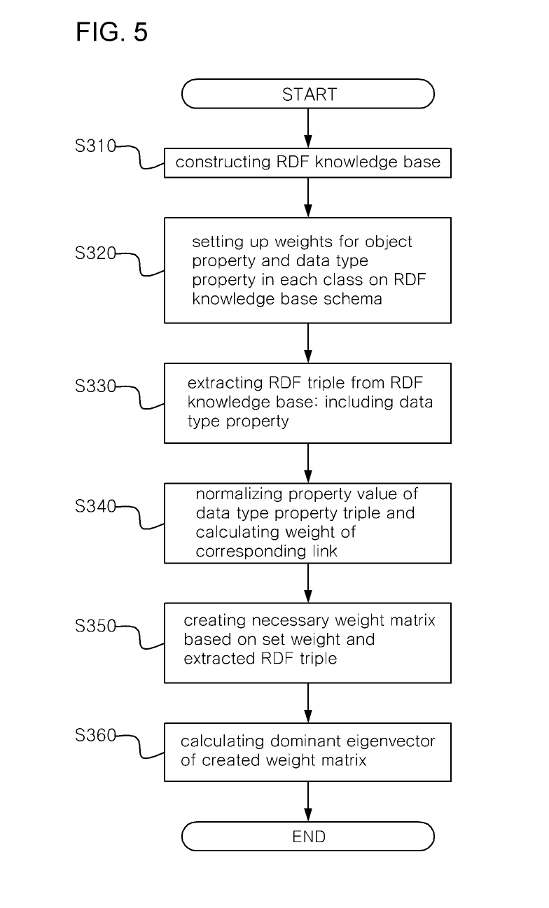

Once weight values for each property in a class level are determined, weight values of the properties which connect instances are automatically determined. An RDF property consists of an object property when a resource locates in the object and a data type property when a simple character string locates in the object. According to traditional studies previously mentioned, the data type property has been excluded. If the importance is calculated considering only the object property such as the traditional studies, weight values should be set such that the total weight values for the object properties at the step S20 in each class should be 1 (referring to FIG. 3). If a data type property is included in a link analysis, weight values should be set such that the total weight values for the object properties and the data type properties should be 1 (referring to FIG. 4 and FIG. 5).

The equation of setting weight values for an instance_Graph which only includes property links where resources belonging to IR (instance resources in class) locate in both subject and object is as follows.

$${\sum }_{D} {objWt}_{( D , C )} + {\sum }_{D} {subWt}_{( C , D )} = 1 \qquad ( Equation 1 )$$

On the RDF schema, the object weights and subject weights are set in each class considering the relative importance of the property connected to the class. Equation 1 represents a condition for setting weights of class C, objWt_{(D,C)} is an object weight for the property where the domain is class D and a range is class C, and subWt_{(C,D)} is a subject weight for the property where the domain is class C and the range is class D.

Then, the equation of setting weights for an instance_data_Graph which includes property links where resources belonging to the IR locate in the subject and data belonging to SD (character string data not resources) locate in the object is as follows.

$${\sum }_{D} {objWt}_{( D , C )} + {\sum }_{D} {subWt}_{( C , D )} + {\sum }_{q} {dpWt}_{q} = 1 \qquad ( Equation 2 )$$

dpWt_{q} is the subject weight for a data type property q connected to C. If dpWt_{q}=0 for every q, Equation 2 becomes the same as Equation 1.

Like this, after setting the weight values in each class on the schema at the step S20, an RDF triple composed of three portions, i.e., the subject, the predicate, and the object is extracted at step S30 from the RDF knowledge base constructed at the step S10.

In addition, a class-oriented weight value matrix is created at step S40 based on the weights set at the step S20 and the RDF triple extracted at the step S30, and a dominant eigenvector is calculated by calculating the created class-oriented weight value matrix. Based on this, a resource importance score vector is obtained at step S50.

When creating the class-oriented weight value matrix, one weight value matrix is used to obtain the dominant eigenvector and calculate the importance of resource in ClaRIOne (Class-oriented Resource Importance-One) while two matrices, i.e. object and subject weight value matrices, are made to calculate like ClaRITwo (Class-oriented Resource Importance-Two) according to a previous semantic web algorithm. The hardest problem, when the link analysis technique of WWW is applied to the semantic web, is the diversity of schema caused by randomness of RDF link direction. According to the ClaRIOne, one importance score unrelated to link directions is calculated instead of the object and subject scores which change according to the schema, and this is similar to people's evaluation method. This is the worth of the ClaRIOne

Although the ClaRITwo also has the excellence in solving TKC effectively compared to the previous algorithm, the ClaRIOne is relatively superior to the ClaRITwo in the diversity of the schema which occurs because the directions of RDF link are arbitrary. For this reason, the ClaRIOne is mainly explained in the present invention.

Above all, to calculate the importance of resource iteratively, for instance_graph G=(V,E), let V={1,2, . . . ,N} be a set of resources having N number of resources, and E be a set of directional links which links a resource r (1≦r≦N) in V to another resource k (1≦k≦N) in V. In this case, after setting the weights in each class at the step S20, the ClaRIOne is calculated and the weight matrix M is defined as follows.

Mᵣₖ=wᵣₖ,

wᵣₖ (0≦wᵣₖ≦1) is the weight value to be multiplied with the importance score of resource k when calculating the importance score of resource r. This is set depending on the relative importance of the corresponding property and can be an object weight or a subject weight of a property link connecting the resources r and k. In the following algorithm, g^{r} is the importance score of the resource r (1≦r≦N), and g without the superscript is (N×1) vector containing all the importance scores of N number of resources.

\textcircled{1} initialization : g₀^{r}=1, (1≦r≦N).

\textcircled{2} iteration: Until g converges, repeat the following steps for i=1,2, . . . ,m,.

a. For each resource r, calculate the equation below.

$${g}_{i}^{\cdot r} = {\sum }_{k} {g}_{i - 1}^{k} \times {w}_{rk} \qquad ( Equation 3 )$$

b. Normalize gᵢ^{.} to get gᵢ. The normalization condition is the equation below.

$${\sum }_{r} {( {g}_{i}^{r} )}^{2} = 1$$

\textcircled{3} Return gₘ.

The iterative algorithm described above is based on the property that the vectors gained at each step converge in a certain direction. If the direction the vectors converge is determined, the ranking of the vector components for representing resources will no longer change. In this way, the final vector can be used for the ranking of resources.

If M is a diagonalizable matrix with a unique dominant eigenvalue and z is not orthogonal to the dominant eigenvector of M, then Mⁱz converges in the direction of the dominant eigenvector of M as i increases (matrix convergence property 1).

If M is a non-diagonalizable matrix with a unique dominant eigenvalue and z is not orthogonal to the subspace of eigenvectors and generalized eigenvectors of M associated with the dominant eigenvalue, then Mⁱz also converges in the direction of the dominant eigenvector of M as i increases (matrix convergence property 2).

The Perron-Frobenius theorem states that a nonnegative and primitive matrix A has a unique positive dominant eigenvalue.

If we convert Equation 3 into a matrix form for N resources, it becomes gᵢ^{.}=Mgᵢ₊₁. This becomes g₁^{.}=Mg₀ when i=1, resulting in g₁=n₁Mg₀ when n₁ is a constant multiplied during the normalization procedure. When i=2 continuously, the matrix expression becomes g₂^{.}=Mg₁=n₁M²g₀, resulting in g₂=n₁n₂M²g₀ when n₂ is a normalization constant. The importance score vector gᵢ becomes a unit vector to Mⁱg₀ direction through i^{th} iteration as described above. As M is a nonnegative weight value matrix and can be considered to be primitive under the assumption that link connection is big enough such as in most graph applied questions, M has a unique positive dominant eigenvalue by Perron-Frobenius theorem. Resultantly, if the matrix convergence property 1 and 2 are applied to the previous Mⁱg₀, the ultimate importance score vector becomes the unit dominant eigenvector of M, when g₀ is consistent with the respective conditions.

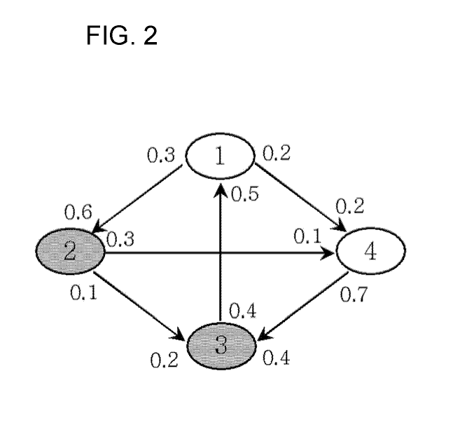

An example of a class-oriented weight value matrix of the present invention will be described, referring to FIG. 2.

Simply suppose a domain shown in FIG. 2 exists and only one instance is included in each class, the weight matrix M for FIG. 2 is constructed as below in calculating the importance of resource of ClaRIOne which is irrelevant to the link direction.

$${g}_{i}^{\cdot r} = {Mg}_{i - 1} \\ [ \begin{matrix}{g}_{i}^{\cdot 1} \\ {g}_{i}^{\cdot 2} \\ {g}_{i}^{\cdot 3} \\ {g}_{i}^{\cdot 4}\end{matrix} ] = [ \begin{matrix}0 & 0.3 & 0.5 & 0.2 \\ 0.6 & 0 & 0.1 & 0.3 \\ 0.4 & 0.2 & 0 & 0.4 \\ 0.2 & 0.1 & 0.7 & 0\end{matrix} ] [ \begin{matrix}{g}_{i - 1}^{1} \\ {g}_{i - 1}^{2} \\ {g}_{i - 1}^{3} \\ {g}_{i - 1}^{4}\end{matrix} ]$$

Then, the dominant eigenvector is calculated by calculating the class-oriented weight value matrix through the previously mentioned step S50. After obtaining the resource importance score vector, it is determined whether SPARQL query for obtaining results according to ranking scores through ontology construction tools is input at step S60. If the SPARQL query is input, the result of corresponding SPARQL query is approached at step S70.

And then, the query results according to the ranking scores that were calculated at the step S50 are sorted and displayed on the screen at step S80.

In other words, when SPARQL query is input, corresponding results are re-sorted and shown according to the importance score with the importance which was already calculated. For example, if there is a SPARQL query tab in protégé which is an ontology construction tool and query is input in the tab, the results corresponding thereto are shown. These results can be seen on the screen using MS Visual Basic after re-sorting the results by protégé-OWL (Ontology Web Language) API.

Meanwhile, FIG. 3 is a flowchart of explaining processes for calculating the importance of resource considering only object property in previously mentioned FIG. 1.

As shown, after RDF knowledge base is constructed at step S110 by using various tools for supporting ontology construction, the sum of weight values in each class is set to be 1 considering only the object property on the RDF knowledge base schema at step S120.

After that, the RDF triples composed of three portions, i.e., the subject, the predicate, and the object are extracted at step S130 by removing the data type property from the RDF knowledge base constructed at the step S110, and the class-oriented property weight value matrix is created at step S140 on the basis of the weight values set by considering only the object property at the step S120 and the RDF triple without data type property extracted at the step S130.

Then, the dominant eigenvector is calculated by calculating the class-oriented property weight value matrix created at the step S140, and the resource importance score vector is obtained at step S150.

FIG. 4 is a flowchart of explaining processes for calculating the final importance of resource by applying the importance set by considering only the object property in previously mentioned FIG. 1 and the normalized data type property.

As shown, after RDF knowledge base is constructed at step S210 by using various tools for supporting ontology construction, the sum of the weight values for the object property and the data type property in each is set to be 1 on the RDF knowledge base schema at step S220.

After that, the RDF triple composed of three portions, i.e., the subject, the predicate, and the object including the data type property is extracted from the RDF knowledge base at step S230, and the weight value for the object property is readjusted at step S240 by excluding the data property from the weight value set at the step S220.

Then, a class-oriented property weight value matrix is created at step S250 on the basis of the weight value which was readjusted at the step S240 and object property RDF triple obtained by excluding the data type property. After that, the dominant eigenvector is calculated at step S260 by calculating the class-oriented weight value matrix which was created at the step S250.

In addition, the data type property RDF triple extracted at the step S230 is normalized at step S270.

Next, the normalized value of the resource importance according to the dominant eigenvector which was calculated at the step S260 and that of data type property calculated at the step S270 are added up to obtain the resource importance score vector at step S280.

FIG. 5 is a flowchart of explaining processes for calculating the importance of resource considering the object property and the data type property in previously mentioned FIG. 1.

As shown, after RDF knowledge base is constructed at step S310 by using various tools for supporting the ontology construction, the sum of the weight values for the object property and the data type property in each class is set to be 1 on the RDF knowledge base schema at step S320.

Then, the RDF triple composed of three portions, i.e., the subject, the predicate, and the object including the data type property is extracted at step S330 from the RDF knowledge base constructed at the step S310. The data type RDF triple extracted at the step S330 is normalized and the weight values for corresponding links are calculated at step S340.

Then, after the class-oriented property weight value matrix is created at step S350 on the basis of the weight value which was set at the step S340 and the RDF triple extracted at the step S330, the dominant eigenvector is calculated by calculating the class-oriented weight value matrix which was created at the step S350 and the resource importance score vector is obtained at step S360.

The experiment result obtained by applying the process for ranking semantic web resources according to the present invention will be explained in detail as follows.

Referring to FIG. 3 which reflects only the object property, a conventional method (Predicate-oriented Resource Importance; PreRI) in which the weight values are set with respect to the property is compared with the methods (ClaRIOne and ClaRITwo) in which the weight values are set with respect to the class. In addition, referring to FIG. 4 and FIG. 5 which reflect the object property and the data type property, a method for normalizing the scores obtained by analyzing a link structure through the ClaRIOne and the data type property and adding up the normalized values by multiplying a predetermined weight values thereto (shown in FIG. 4), and a method for converting the data type properties into link weight values for each instance and being included in the link analysis (shown in FIG. 5) will be described.

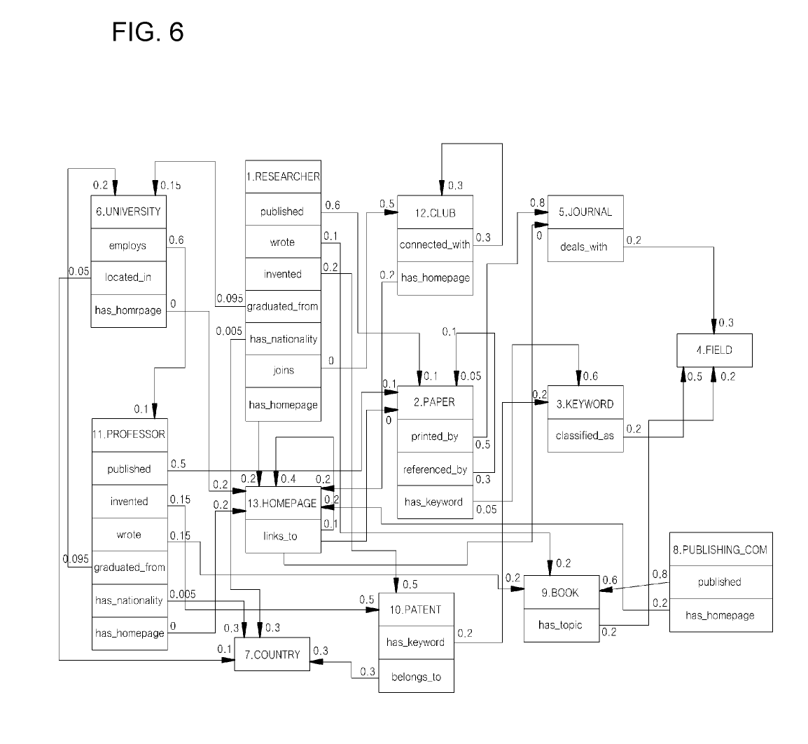

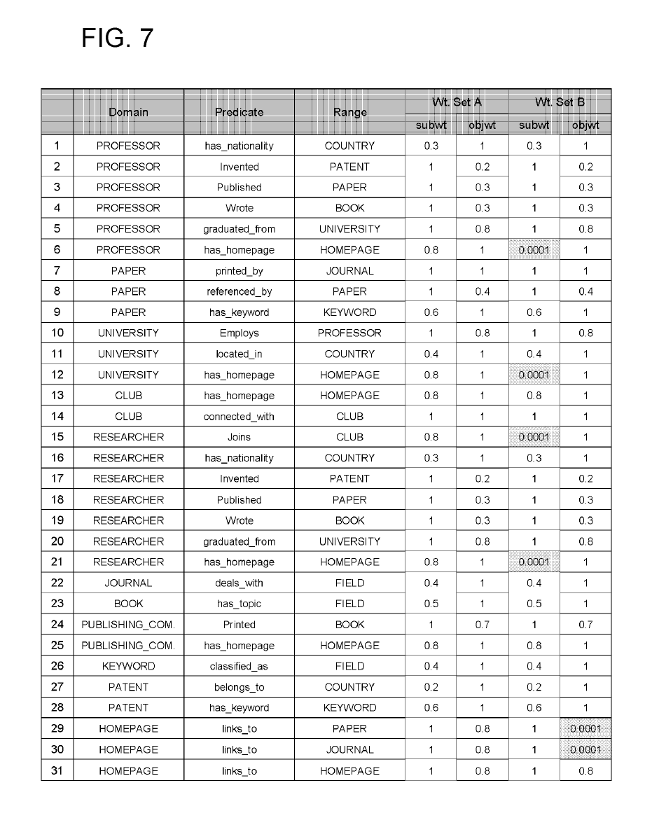

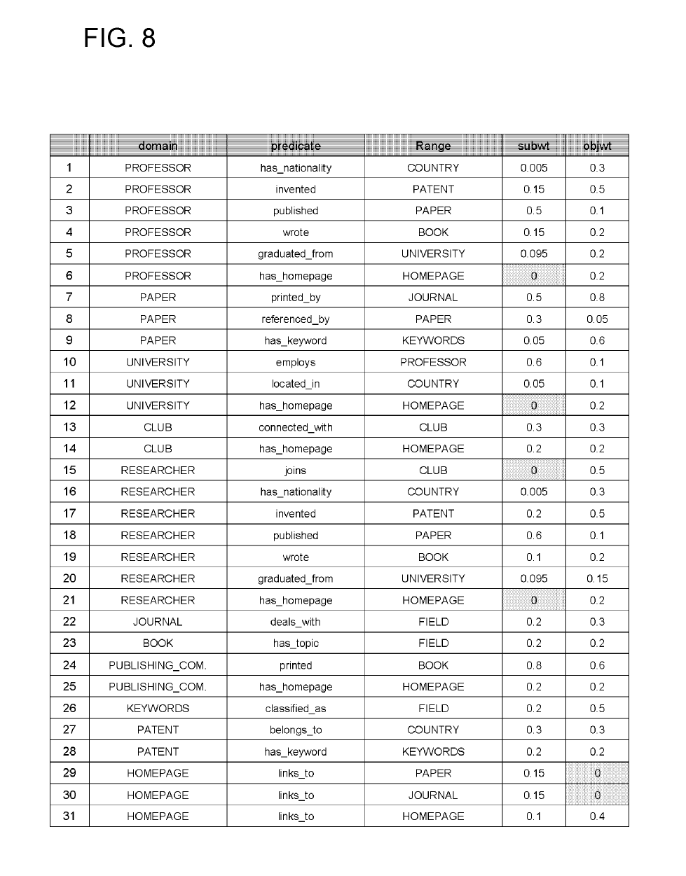

Firstly, FIG. 3 which reflects only the object property, targets a domain with a schema shown in FIG. 6, and it is assumed that a hierarchy among classes and a hierarchy among properties which are provided above the RDF schema when constructing the ontology are simplified and there is only one class. The weight values for each property are set suitable for each case as shown in FIG. 7 and FIG. 8 and can be varied depending on the context. The results of each method can change depending on the predetermined weight values. However, it is adjudged that the comparison of general effectiveness would not be affected much.

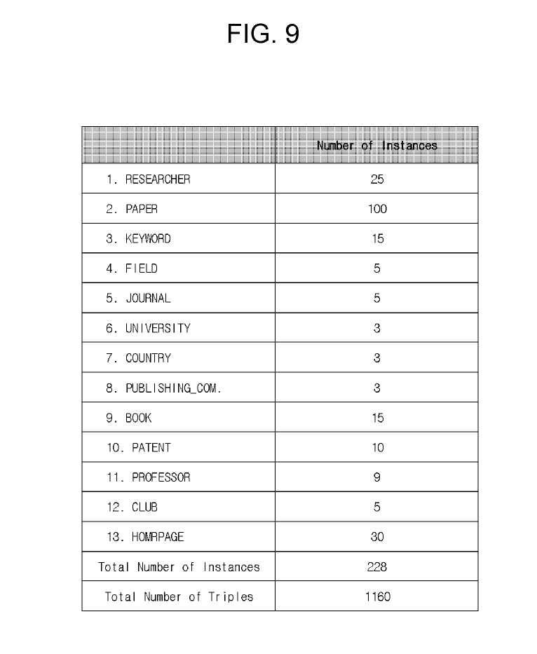

FIG. 9 shows the number of instances in each class shown in FIG. 6 and the number of the triples that describe the information thereof.

All of three methods described herein use the same triple set. The fragment identifier form without URL and ‘#’ was used as the name of instance and property for brevity when the triple information was composed. The instance name is formed as ‘class name-class number-instance number’. The dataset was designed for the smaller numbered instance to have the higher score according to the standard of FIG. 8. That is, when making the same numbers of link connections to random property, the smaller numbered instance in a class is connected to the smaller numbered instance in another class. Or, the smaller instance number may have the more link connections corresponding to random property.

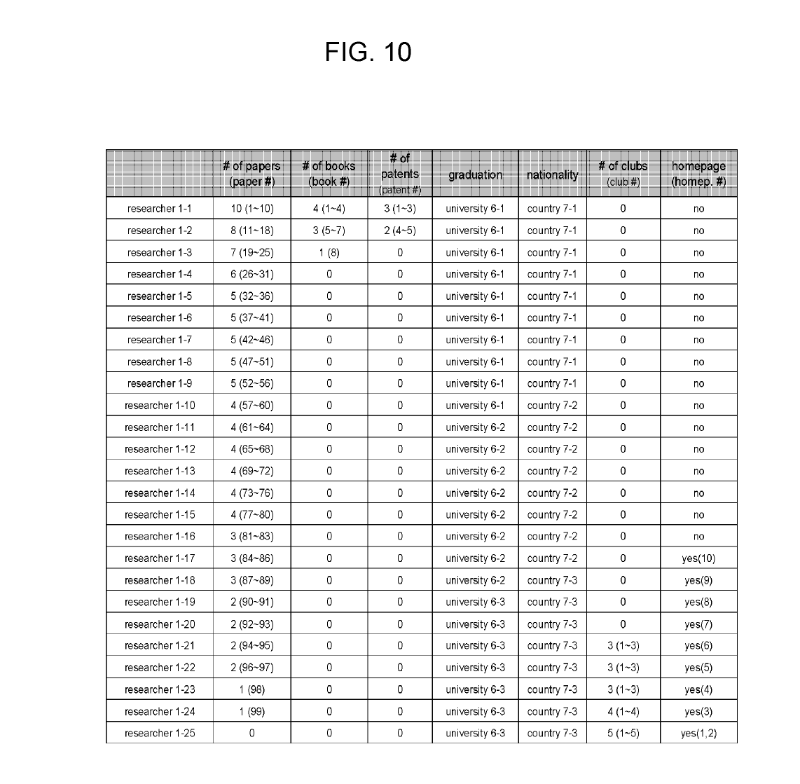

In addition, the class RESEARCHER is chosen to examine the ability of the ClaRITwo and the ClaRIOne to solve the TKC effect problem. The analysis of the property values of RESEARCHER instances is shown in FIG. 10. ‘Researcher 1-1’ publishes 10 papers, while ‘Researcher 1-25’ does not publish any. To make the TKC, many links are created between ‘researchers 21-25’ and clubs, ‘researchers 17-25’ and homepages, clubs and homepages, homepages and homepages, and homepages and other classes. ‘Researcher 1-25’ joins 5 clubs, which should not affect the importance rating.

On this dataset, we will check how three ranking algorithms (PreRI, ClaRITwo, ClaRIOne) rank each instance resource. We will also examine if the algorithm of the class-oriented approach makes the ranking results consistent with the given triple information for other classes, and check if the ranking score of the corresponding resource is actually affected when the influential link on the importance of resource is added or deleted.

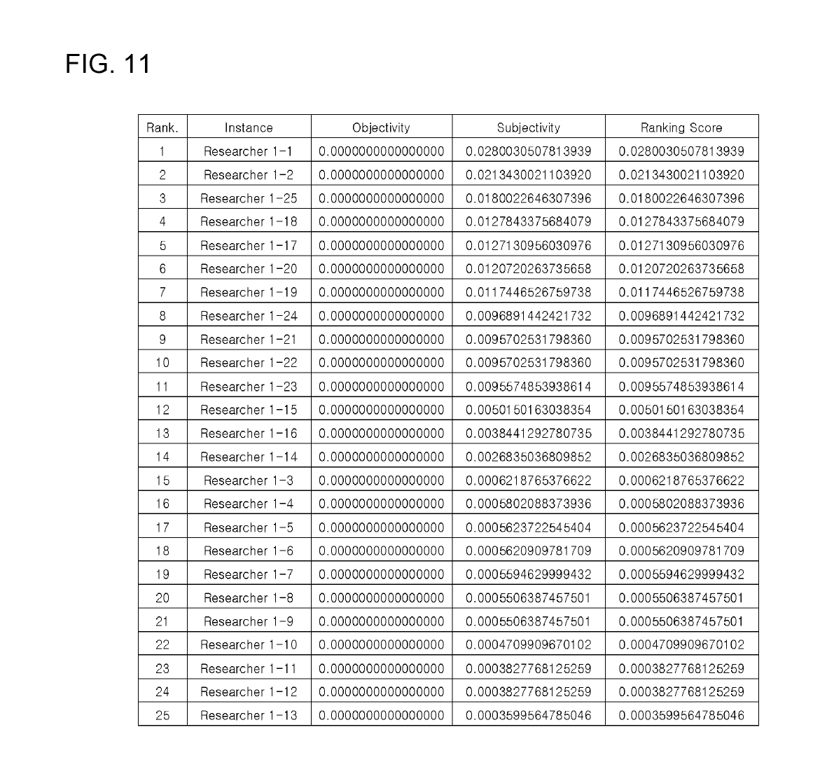

The ranking result of the RESEARCHER class by PreRI is shown in FIG. 11. Object score is 0 because, as shown in the schema of FIG. 6, the instance in RESEARCHER class can only be positioned in the subject, not object of the triple. The reason why the link structures connected to RESEARCHER class are designed like this is that ClaRITwo or ClaRIOne proposed in the present invention is compared more objectively with the original study in which object or subject was compared separately or the sum of two scores was used in an arbitrary ratio. With the weight set of property-oriented approach, ‘researcher 1-25’, who does not publish any paper, is ranked higher than ‘researcher 1-3’ who publishes seven papers and writes one book, or ‘researcher 1-4’ who publishes six papers. In addition, other researchers who are linked to clubs or homepages receive high rankings.

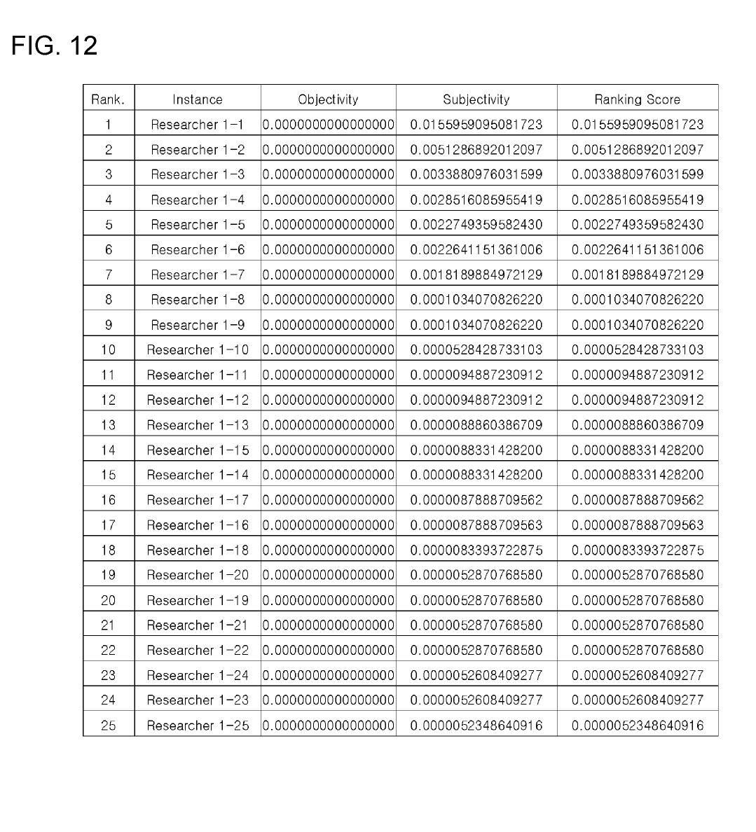

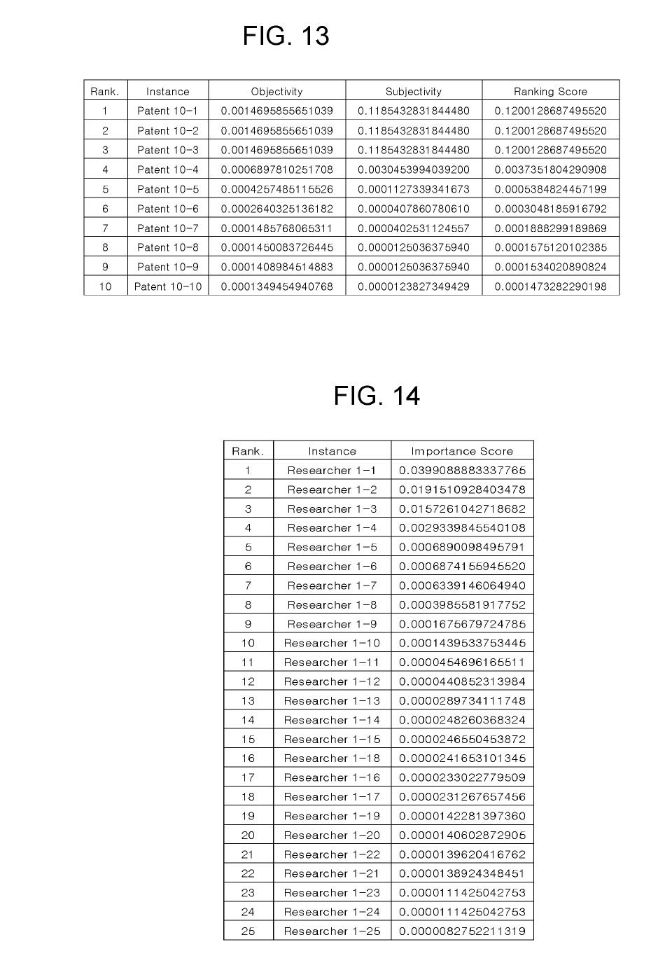

On the other hand, in FIG. 12, we see that the serial numbers are closely consistent with the rankings. Herein, object scores are 0 for the same reason of FIG. 11. The ranking results of PATENT class are presented for the example of the class of which both object score and subject score are positive values.

In ClaRITwo, the object score or the subject score to all instances can be 0 depending on the schema. In the case of FIELD class, two scores are calculated as 0. The reason for this is that the resources in the FIELD class can only be positioned in the object, and naturally, the subject score is 0, as shown in the schema of FIG. 6. The reason why the object score is 0 is that there is no outgoing link other than the link from the neighboring classes, such as JOURNAL, KEYWORD, and BOOK to FIELD. In this way, ClaRITwo has a weakness in that it fails to evaluate some classes in a particular schema although it has an advantage of solving TKC effect.

FIG. 14 shows the ranking results of RESEARCHER class by ClaRIOne. We see that the serial numbers are closely consistent with the rankings according to ClaRIOne and ‘RESEARCHER 1-25’ is evaluated properly. The reason why the ranking is not consistent with the serial number is that there are too many instance numbers in RESEARCHER class and PAPER class, and it is very difficult to form the complex link connections to be precisely proportional thereto considering finest portions. However, when considering the number of papers which is the highest importance in researcher importance, researchers with less papers have never ranked higher than those with more papers.

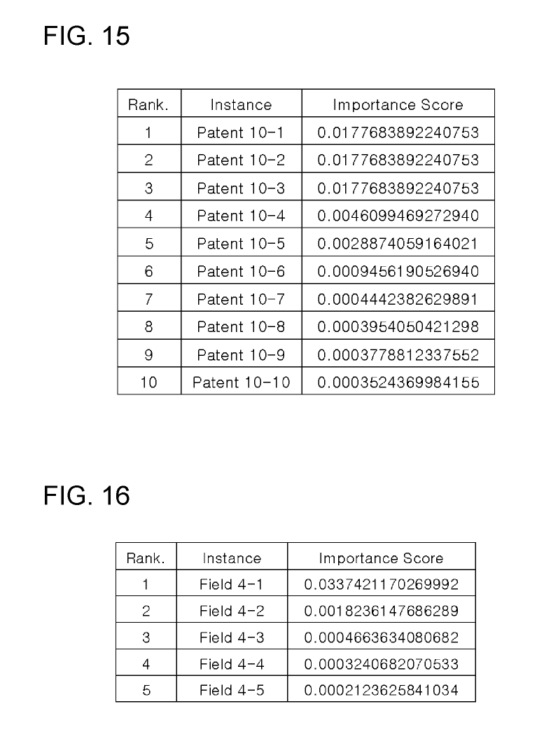

The ranking results of PATENT class by ClaRIOne are shown in FIG. 15 and the rankings are the same as the serial numbers like ClaRITwo. FIELD class, which was not evaluated in ClaRITwo, also shows the same result as FIG. 16.

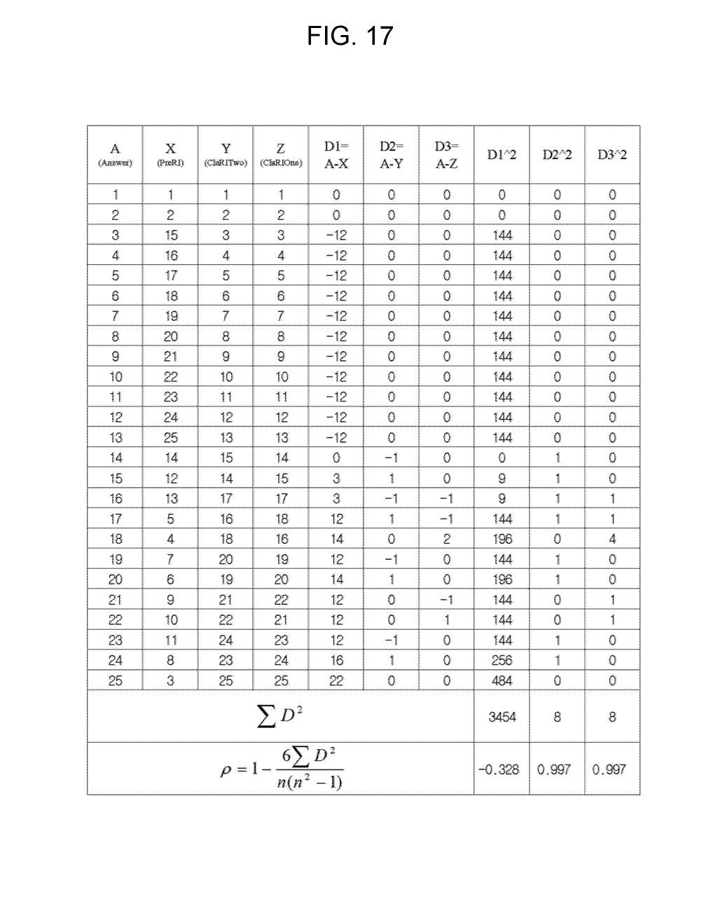

Because of too many numbers of class instance or the complex link connections, it is difficult to make the instance-number order of resources exactly the same as the ranking. However, the number order of instances of resource is adjusted to be generally consistent with the ranking. Therefore, if the ranking becomes consistent with the number order of instances, the algorithm can be assumed to be reasonable. Under this assumption, the Spearman's rho correlation coefficient which verifies rank correlation is calculated for RESEARCHER class as shown in FIG. 17.

Spearman's rho, developed by Spearman who is an English psychologist, is the assessment of independence between variables by verifying the rank correlation. Spearman's rho is a kind of assessments which uses rank of specimen instead of a detected value commonly used in correlation analysis. According to Spearman's rho, a direction of the relation as well as the independence or dependency between the variables can be adjudged.

$$ρ = 1 - \frac{6 \sum {D}^{2}}{n ( {n}^{2} - 1 )}$$

$$( n \text{:} \begin{matrix}size of \\ specimen\end{matrix} , D \text{:} \begin{matrix}difference \\ between ranks\end{matrix} )$$

If the value of ρ is 1, it represents the positive correlation which two variables are consistent with each other. If the value of ρ is −1, it represents the negative correlation. If the value of ρ is 0, it represents they are independent. When checking the independence of two variables, namely that the two variables are not correlated, threshold value of ρ changes according to the size n of specimen and significance level α. If the size n of the specimen is 25, threshold values are 0.26, 0.34, and 0.47 according to the significance level, α of 0.1, 0.05, and 0.01, respectively. If ρ obtained from the specimen is larger than the threshold value, two variables may be correlated to each other. On the contrary, if ρ obtained from the specimen is smaller than the threshold value, two variables may not be correlated to each other.

In FIG. 17, first row A stands for the number order of instances, that is, the ranking results justified in terms of FIG. 8, and X, Y, Z stand for the rankings of PreRI, ClaRITwo, ClaRIOne, repectively. Rho correlation coefficients of PreRI, ClaRITwo, ClaRIOne are calculated as −0.328, 0.997, 0.997 sequentially. Since n equals 25, PreRI represents the negative correlation at the significance level of 10%, and ClaRITwo and ClaRIOne exhibit the strong positive correlation even when the significance level is 1%. This shows that the weight set of PreRI produces a result that is totally different from what a system user intends, especially when there is a TKC. By contrast, ClarITwo and ClaRIOne reflect the intention of users almost 100% even when there is a TKC.

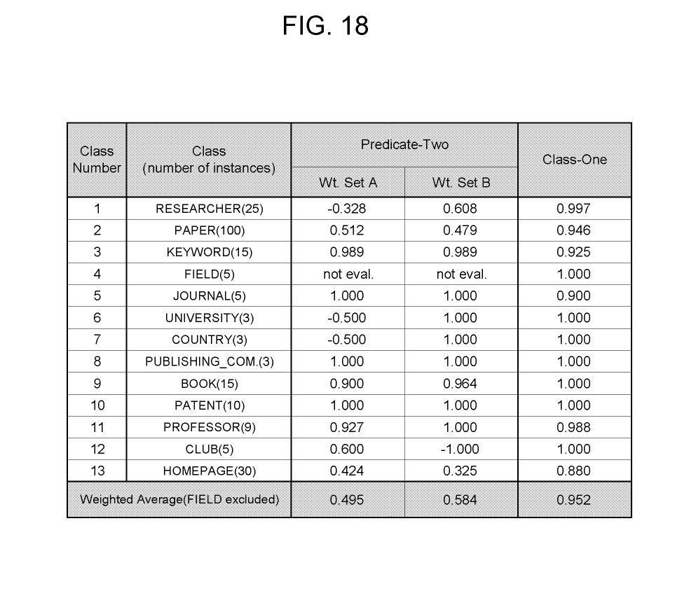

Rho correlation coefficient of all the classes is shown in FIG. 18. The ranking scores of PreRI and ClaRITwo are calculated by adding up the objectivity and subjectivity scores for the purpose of comparison with ClaRIOne. Except for the Field class which is affected by the link direction and is not evaluated through PreRI and ClaRITwo, the average results obtained by weighting the weight proportion to the instance number to the rho correlation coefficient for each class shows ClaRIOne exhibits the best result of 0.952. In addition, PreRI and ClaRITwo exhibit the result of 0.495 and 0.845, respectively.

If the weight value is set class-oriented like this, it is stable because it excludes links that do not influence the importance even though there are strong TKC nodes. It gives an efficient guideline to the perfection of expressing information, another limit of the previous study as well as TKC. It is a natural result that accurate ranking scores are obtained when any information about the properties which affect the importance on the ontology schema is not omitted. Also, the phenomenon that a certain resource obtains high score because of its commonness is in the same vein as TKC effect.

In class-oriented algorithm, ClaRIOne which is calculated with a whole importance is superior to ClaRITwo which is calculated by exchanging partial importance of object or subject scores from the viewpoint of ranking ability. In addition, it is not sensitive to the diversity of schema by the link direction. Therefore, ClaRIOne may be an excellent algorithm. ClaRIOne shows, as expected, increased or decreased importance scores even when link connections to significant property of certain resources are added or deleted.

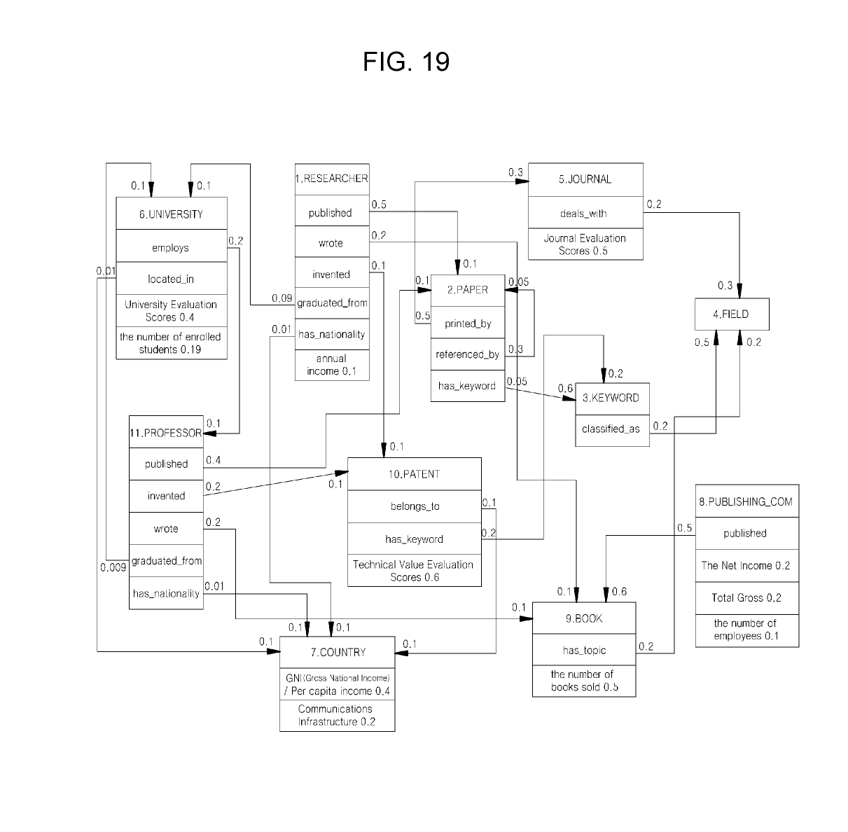

Next, the methods of FIG. 4 and FIG. 5, considering both object property and data type property, are based on a domain like FIG. 19 which removed ‘CLUB’ and ‘HOMEPAGE’ to have been used for TKC in FIG. 6 and added data type property.

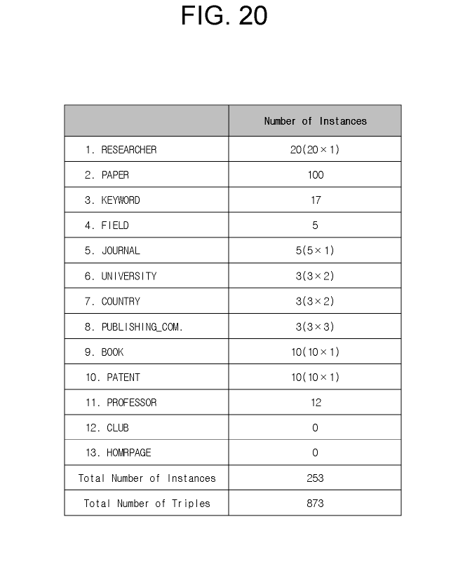

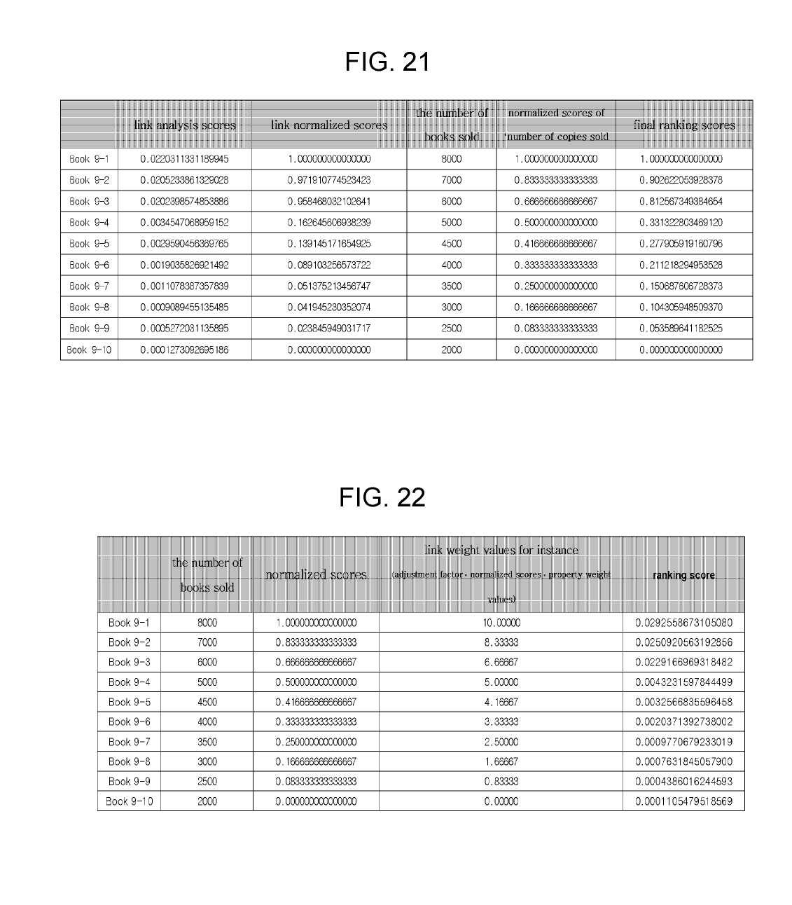

Herein, results obtained by applying two methods are shown. One is that the scores obtained by analyzing link structure in FIG. 4 and normalized data type property value are added with the predetermined weight after selecting ‘BOOK’ class which has high rate of data type property and not inconsiderable number of instances. The other is that data type property value in FIG. 5 is converted into link weight for each instance and is calculated including it in link analysis from the beginning. Property value for instance of ‘number of copies sold’ which is data type property is shown in both FIG. 21 and FIG. 22 showing experiment results. FIG. 20 shows the number of triple that describes the instance numbers of classes used in a domain and data type property value between these instances. The numbers in parentheses refer to the numbers of dummy resources to data type property.

FIG. 21 shows the sum of normalized scores of link analysis results of BOOK instances which is obtained considering only object property by ClaRIOne in FIG. 19 and normalized scores of ‘number of copies sold’ which is data type property with the predetermined weights.

FIG. 22 shows the result that are calculated by including link analysis of ClaRIOne from the beginning after ‘number of copies sold’ property value is normalized and converted into link weight for each instance. Compared with link analysis scores of FIG. 22, the ranking scores of FIG. 21 show higher maximum value and lower minimum value. It seems that the difference of ‘number of copies sold’ value is reflected and the ranking does not change because lower serial number is set to higher ‘number of copies sold’ value.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

The present invention can solve TKC effect which occurred when link structure is analyzed focusing on properties and used as ranking scores. Also, it provides how to rank semantic web resources efficiently by introducing the concept of interactions between resources which are irrelevant to link directions and solving the problem of diversity of schema caused by the arbitrariness of RDF link directions.

What is claimed is:

1. A process for ranking semantic web resources, comprising:
establishing an RDF knowledge base using various tools that support the establishment of ontology;
setting object and subject weights for an object type property and a weight for a data type property in each class on a schema composed of classes that constitute a domain and of properties that describe relationships between these classes;
extracting from the RDF knowledge base an RDF triple composed of a subject, a predicate, and an object;
creating a weight matrix of class-oriented property based on the set weights and the extracted RDF triple; and
operating the created weight matrix of class-oriented property to calculate a dominant eigenvector and obtain a resource importance score vector.

2. The process for ranking semantic web resources of claim 1, after obtaining the eigenvector and the resource importance score vector, further comprising:
determining whether SPARQL query is input to obtain the result of the ranking scores through the ontology establishment tool;
approaching the result of corresponding SPARQL query when the SPARQL query is input; and
sorting and displaying on a screen query results by the ranking scores.

3. The process for ranking semantic web resources of claim 1, wherein the weights are set such that the sum of the weights in each class is to be 1 considering only the object property.

4. The process for ranking semantic web resources of claim 1, wherein the weights are set such that the sum of weights for the object property and the data type property is to be 1.

5. A process for ranking semantic web resources, comprising:
establishing an RDF knowledge base using various tools that support the establishment of ontology;
setting a sum of weights in each class to be 1 considering only object property in each class on an RDF knowledge base schema;
extracting an RDF triple composed of a subject, a predicate, and an object from the RDF knowledge base by excluding a data type property,;
creating a weight matrix of class-oriented property based on the weights considering only the object property and the RDF triple excluding the data type property; and
operating the created weight matrix of class-oriented property to calculate a dominant eigenvector and obtain a resource importance score vector.

6. A process for ranking semantic web resources, comprising:
establishing an RDF knowledge base using various tools that support the establishment of ontology;
setting a sum of weights for object property and data type property in each class to be 1 on an RDF knowledge base schema;
extracting an RDF triple composed of a subject, a predicate, and an object from the RDF knowledge base including a data type property;
readjusting weights for the object property among the set weights excluding the data type property;
creating a weight matrix of class-oriented property based on the readjusted weights and the RDF triple for the object property excluding the data type property;
operating the created weight matrix of class-oriented property to calculate a dominant eigenvector;
normalizing property values of the extracted RDF triple for the data type property;
obtaining a resource importance score vector by adding up the normalized value of an importance of resource by dominant eigenvector and the normalized property values for the data type property.

7. A process for ranking semantic web resources, comprising:
establishing an RDF knowledge base using various tools that support the establishment of ontology;
setting a sum of weights for object property and data type property in each class to be 1 on an RDF knowledge base schema;
extracting an RDF triple composed of a subject, a predicate, and an object from the RDF knowledge base including a data type property;
normalizing property values of the extracted RDF triple for the data type property;
calculating a weight of a corresponding link;
creating a weight matrix of class-oriented property based on the set weights and the extracted RDF triple;
operating the created weight matrix of class-oriented property to calculate a dominant eigenvector and obtain a resource importance score vector.
